(19) United States
(12) Patent Application Publication
(10) Pub. No.: US 2017/0017998 A1
(43) Pub. Date: Jan. 19, 2017

(54) DETERMINING CONTEXT AND MINDSET OF USERS

(71) Applicant: Adobe Systems Incorporated, San Jose, CA (US)

(72) Inventors: Anmol Dhawan, Ghaziabad (IN); Walter W. Chang, San Jose, CA (US); Ashish Duggal, Delhi (IN); Peter Raymond Fransen, Soquel, CA (US); Sachin Soni, New Delhi (IN)

(21) Appl. No.: 14/802,249

(22) Filed: Jul. 17, 2015

(51) Int. Cl. G06Q 30/02; G06K 9/00

(52) U.S. Cl. CPC G06Q 30/0255; G06Q 30/0261; G06Q 30/0271; G06K 9/00302; G06K 9/00288

(57) ABSTRACT

Embodiments of the present invention provide systems and methods for generating personalized targeted content based on user sentiment and micro-location. A user's sentiment toward content, or items represented by the content, may be used to personalize targeted content when a user is determined to be near items (e.g., products) related to the content. Micro-location technology may be used to identify when the user is in an appropriate location to receive such personalized targeted content. Content may be provided to a user based on identifying a positive user sentiment toward particular portions of the content. Additionally, content may be provided to a user upon identifying a negative user sentiment toward particular portions of the content in order to allay concerns. User sentiments may be dynamically updated over time or as exposure to content changes.

### BACKGROUND

Providing targeted content to an individual is a constantly evolving trend in online communities. Today, techniques for providing targeted content are typically generalized meaning that individuals may receive targeted content based solely on location or potentially something slightly more specific such as browsing history of the individual. By way of example only, a user may be provided with targeted content when the user is detected to be in a certain geographical location. Oftentimes, a user approaching a particular item or product may have an opinion or perception of the item or product. In conventional systems, however, such a user sentiment is not utilized to select targeted content for the user as the user approaches or comes within a vicinity of the particular item. Foregoing use of the context or mindset of the user can result in ineffective targeting thereby reducing user satisfaction, conversion rates, and the like.

### SUMMARY

Embodiments of the present invention are directed to determining a context or mindset (i.e., a sentiment) of a user for use in providing targeted content to the user. Such targeting may be accomplished utilizing the sentiment of the user and a location of the user. In this regard, as a user approaches an item, or is within a proximity or vicinity of an item, the user is provided with targeted content in accordance with the sentiment of the user (e.g., sentiment of the user in relation to the item within the vicinity of the user).

To provide such targeted content, embodiments of the invention utilize, for example, content tracking technology, facial expression recognition technology, natural language processing, micro-location technology, and the like. Content is analyzed to identify content that is, for example, read carefully, skimmed, or skipped. Content may be categorized as customer/user reviews, product descriptions, product features, etc., and may be further categorized as read carefully, skimmed, or skipped. Natural language processing techniques may be used to identify a frequency of keywords within the content. The content may also be associated with facial expressions using facial expression recognition technology. This data may be used to score the content to determine a sentiment of a user. Content deemed to be interesting to a user with a positive mindset may be associated with the user's profile to create an enhanced user profile. The enhanced user profile may also include a separate listing that details content that is not interesting to a user, associated with a negative mindset, or the like. This content analysis is utilized in combination with micro-location technology to generate personalized targeted content for the user as the user is near, approaching, or within a vicinity of an item. The personalized targeted content may be provided in multiple ways including to several different types of devices.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram showing a system for generating personalized targeted content, in accordance with an embodiment of the present invention;

FIG. 2 is a flow diagram showing a method for generating personalized targeted content, in accordance with an embodiment of the present invention;

FIG. 3 is another flow diagram showing a method for generating personalized targeted content, in accordance with embodiments of the present invention;

FIG. 4 is another flow diagram showing a method for generating personalized targeted content, in accordance with embodiments of the present invention;

FIG. 5 is an exemplary user interface showing content viewed, in accordance with embodiments of the present invention; and

FIG. 6 is a block diagram of an exemplary computing environment suitable for use in implementing embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Providing targeted content to an individual is a constantly evolving trend in online communities. Today, techniques for providing targeted content are typically generalized meaning that individuals may receive targeted content based solely on location or potentially something slightly more specific such as browsing history of the individual. By way of example only, a user may be provided with targeted content when the user is detected to be in a certain geographical location. Oftentimes, a user approaching a particular item or product may have an opinion or perception of the item or product. In conventional systems, however, such a user sentiment is not utilized to select targeted content for the user as the user approaches or comes within a vicinity of the particular item. Foregoing use of the context or mindset of the user can result in ineffective targeting thereby reducing user satisfaction, conversion rates, and the like.

Embodiments of the present invention are directed to determining a context or mindset (i.e., a sentiment) of a user for use in providing personalized targeted content to the user at the appropriate time based on a micro-location of the user. Such targeting may be accomplished utilizing the sentiment of the user and a location of the user. In this regard, as a user approaches an item, or is within a proximity or vicinity of an item, the user is provided with targeted content in accordance with the sentiment of the user (e.g., sentiment of the user in relation to the item within the vicinity of the user).

To provide such personalized targeted content, embodiments of the invention utilize, for example, content tracking technology, keyword level sentiment analysis, facial expression recognition technology, natural language processing (NLP), micro-location technology, and the like. Each of the content tracking technology, facial expression recognition technology, NLP, etc., may be used to identify a sentiment of the user that can be used in combination with a micro-location of a user to provide personalized targeted content to the user that is appropriately timed and targeted in accordance with the micro-location of the user and the sentiment of the user.

The sentiment of the user may be identified in a variety of ways, as previously mentioned. Content tracking technology (e.g., eye tracking technology or scroll tracking technology) for instance, may analyze content to identify content including customer/user reviews, product descriptions, product features, etc., that is, for example, read carefully, skimmed, or skipped. Content that is read thoroughly may, for example, be identified as being of interest to a user while content that is skipped is likely not of interest to a user.

Additionally, natural language processing techniques may be used to identify a frequency of keywords within the content to further refine a user's sentiment. In particular, NLP may be used to identify a frequency of keywords within content of interest to the user. For instance, if a portion of content that is read thoroughly is a user review on a camera of a smartphone, the camera feature is likely a feature of interest. In embodiments, keywords may be provided by, for example, the content provider such that the system can identify the frequency of already-provided keywords.

Keyword level sentiment analysis technology may also be utilized to provide keyword sentiment. The keyword sentiment will portray the overall tone of content. For example, if a user review states “great battery life but camera quality has gone down” then a keyword sentiment for “battery” is likely positive but the keyword sentiment for “camera” is likely negative. Thus, content that is of interest to a user is identified and a frequency of keywords is identified using, for example, NLP technology and a keyword level sentiment is then identified for those keywords appearing with a frequency above an identified threshold.

The content may also be associated with facial expressions using facial expression recognition technology to further refine a sentiment. For instance, a user's facial expression could be identified as happy, sad, scared, disgusted, surprised, angry, etc. while viewing content. This facial expression characterization may be considered in assigning a user sentiment related to a portion of content.

This sentiment data (e.g., content tracking results, keyword frequency and sentiment, and facial expressions, etc.) may be used to score the content to determine a sentiment of a user. Using the sentiment data, content deemed to be interesting to a user with a positive mindset may be including in a first listing that is associated with the user's profile to create an enhanced user profile. The enhanced user profile may also include a second listing that details content that is not interesting to a user, associated with a negative mindset, or the like. The listings may be ranked according to sentiments associated therewith. For instance, by way of example only, content that was associated with a very positive sentiment (based on a numerical value score assigned thereto, as discussed in further detail below) is ranked higher than another item of content associated with a lower positive sentiment and, thus, personalized targeted content may be focused in on the content associated with the very positive sentiment.

This sentiment analysis is utilized in combination with micro-location technology to generate, select, or provide personalized targeted content for the user as the user is near, approaching, or within a proximity or vicinity of an item. Near or approaching may be defined as a distance that is within a predetermined distance from an item of interest (e.g., a product, a venue, etc.). Micro-location technology may be utilized to determine when a user/customer is near or approaching a product. Any micro-location technology may be utilized including beacons, near field communication (NFC), and the like. The personalized targeted content may be provided in multiple ways including to several different types of devices. This combination of user sentiment and micro-location may provide an increased return on investment for content targeting.

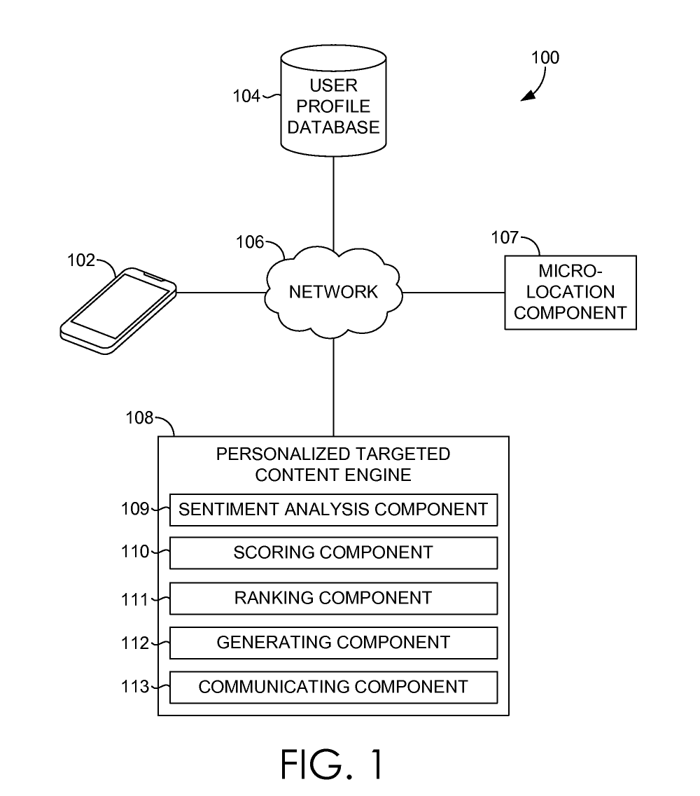

Turning now to FIG. 1, a block diagram is provided illustrating an exemplary system 100 in which some embodiments of the present invention may be employed. It should be understood that this and other arrangements described herein are set forth only as examples. Other arrangements and elements (e.g., machines, interfaces, functions, orders, and groupings of functions) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The system 100 in FIG. 1 includes a computing device 102, a user profile database 104, a network 106, a micro-location component 107, and a personalized targeted content engine 108. Network 106 may be wired, wireless, or both. In embodiments, the personalized targeted content engine 108, the computing device 102, the user profile database 104, and the micro-location component 107 communicate and share data with one another by way of network 106. Network 106 may include multiple networks, or a network of networks, but is shown in simple form so as not to obscure aspects of the present disclosure. By way of example, network 106 can include one or more wide area networks (WANs), one or more local area networks (LANs), one or more public networks, such as the Internet, and/or one or more private networks. Where network 106 includes a wireless telecommunications network, components such as a base station, a communications tower, or even access points (as well as other components) may provide wireless connectivity. Networking environments are commonplace in offices, enterprise-wide computer networks, intranets, and the Internet. Accordingly, network 106 is not described in significant detail.

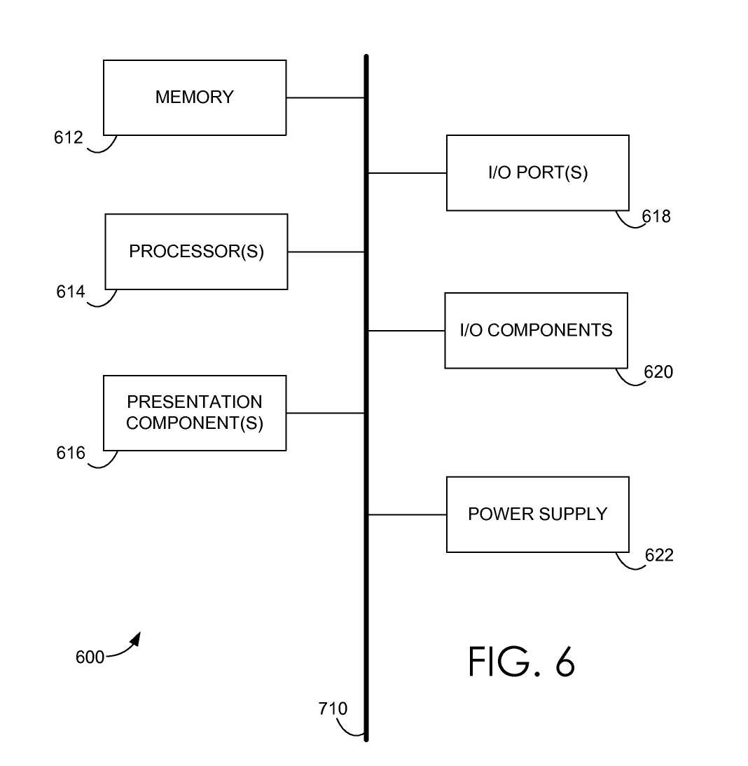

The computing device 102 may be any computing device that is capable of performing various functions described herein, such as the computing device 600 of FIG. 6. Additionally, while only one computing device 102 is illustrated in FIG. 1, multiple computing devices may be utilized to carry out embodiments described herein. Each computing device 102 may be capable of accessing the Internet, such as the World Wide Web. The computing device 102 may take on a variety of forms, such as a personal computer (PC), a laptop computer, a mobile phone, a tablet computer, a wearable computer, a personal digital assistant (PDA), an MP3 player, a global positioning system (GPS) device, a video player, a digital video recorder (DVR), a cable box, a set-top box, a handheld communications device, a smart phone, a smart watch, a workstation, any combination of these delineated devices, or any other suitable device. Further, the computing device 102 may include one or more processors, and one or more computer-readable media. The computer-readable media may include computer-readable instructions executable by the one or more processors.

The user profile database 104 includes one or more user profiles associated with one or more users/customers. The user profile database 104 may include one or more user profiles including typical user profile information such as a user name, demographics of the user, etc. The user profile database 104 may also include enhanced user profiles that include the user sentiment as described herein. The enhanced user profiles may be stored in the user profile database 104 and accessible to any component of the system 100. The enhanced user profiles may also be updated at any time. In embodiments, the enhanced user profiles are updated dynamically or, in real-time, as a user reviews additional content or at any point when any of the sentiment analysis data changes.

The micro-location component 107 may be any micro-location technology capable of identifying a micro-location or transmitting a signal to aid in the determination of a location of one or more entities such as a user, a product, etc. Exemplary micro-location components or technologies may be beacons, near-field communications systems, and the like. Beacons, for example, may be installed in a non-virtual store and configured to transmit a signal that a user device (e.g., a mobile phone) can use to determine a location. The micro-location component 107 works in conjunction with the personalized targeted content engine 108 to provide the personalized targeted content at appropriate times such as when a user is near or approaching an item of interest.

The personalized targeted content engine 108 comprises various components. In one embodiment, computing device 102 comprises the personalized targeted content engine 108 and thus performs the functions that will be described with respect to the personalized targeted content engine 108. In other embodiments, another computing device(s) or platform is responsible for performing the functions that will be described with respect to the personalized targeted content engine 108. As illustrated, the personalized targeted content engine 108 comprises a sentiment analysis component 109, a scoring component 110, a ranking component 111, a generating component 112, and a communicating component 113.

In embodiments, each component of the personalized targeted content engine 108 is not required. For example, some of the functionality may be combined or performed in combination. The components identified herein are merely set out as examples to simplify or clarify the discussion of functionality. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more components may be carried out by hardware, firmware, and/or software. For instance, various functions may be carried out by a processor executing instructions stored in memory.

The personalized targeted content engine 108 facilitates analysis of user sentiment data (e.g., facial expressions, content viewed, keyword sentiments and/or frequencies, etc.) to identify a user sentiment to provide personalized targeted content to the user when the user is in an appropriate location (e.g., near or approaching an item of interest associated with content viewed). The personalized targeted content engine 108 also manages the user sentiments such that as new information is received the user sentiments (and user profiles associated thereto) are updated accordingly. The personalized targeted content engine 108 may provide the personalized targeted content by selecting from pre-provided content, generating new content, or a combination thereof.

The sentiment analysis component 109 is configured to facilitate the identification of user sentiments using one or more technologies. The technologies utilized may include, but are not limited to, content tracking technology, keyword level sentiment analysis, facial expression recognition technology, natural language processing (NLP), and the like. One or more of the content tracking technology, facial expression recognition technology, NLP, etc., may be used to identify a sentiment of the user that can be used in combination with a micro-location of a user to provide personalized targeted content to the user.

Content, as used herein, refers generally to any material viewable by a user on a computing device including, but not limited to, web pages, application data, and the like. The content may be content that is currently being viewed by a user or content that was previously viewed. In the case where content was previously viewed, the sentiment data needed (e.g., keyword frequency, facial expressions, etc.) to perform sentiment analysis may have also been captured so that the sentiment analysis can be performed at a subsequent time as opposed to in real-time for content presently viewed. The content identified may be one or more pages of content within, for example, an application, a web page, and the like.

Returning to FIG. 1, the sentiment analysis component 109 may utilize content tracking technology (e.g., eye tracking technology or scroll tracking technology), as previously described, to identify content including customer/user reviews, product descriptions, product features, etc., that is, for example, read carefully, skimmed, or skipped. Content that is of interest to a user may be identified by identifying content that is read carefully versus content that is skimmed or skipped altogether by using, for example, eye tracking technology or scroll tracking technology. Content that is read thoroughly may, for example, be identified as being of interest to a user while content that is skipped is likely not of interest to a user. Identifying content that is of interest to a user may illustrate a user's mindset to the system 100.

The sentiment analysis component 109 may perform further analysis of content that is identified to be of interest to the user (e.g., content identified as read thoroughly using content tracking technology). For instance, the sentiment analysis component 109 may utilize keyword parsing to identify one or more keywords that contribute to the determined sentiment within the content of interest. Additionally or in the alternative, the sentiment analysis component 109 may facilitate keyword parsing of any content viewed by a user and not just on content of interest.

The keywords to identify may be keywords that have been previously supplied by, for example, the content provider. For instance, a content provider may provide pages for a particular product where the pages include product descriptions, product features, user reviews, etc. The content provider may provide relevant keywords to narrow the keywords for which sentiment analysis is performed. Additionally or alternatively, if the keywords are not previously supplied, the content may be passed through the keyword parser (of the sentiment analysis component 109) to identify keywords related to the subject of the content (e.g., features of a product, amenities of a venue, etc.). Regardless of a method used to obtain an initial set of keywords, the content is passed through the keyword parser to identify a frequency of each keyword.

The frequency of each keyword may be evaluated to determine whether the frequency is greater than a predetermined threshold value. For instance, if the frequency of the keyword is greater than a value X a keyword sentiment value is selected for each keyword. In the event that the frequency is not greater than the predetermined value X, then no keyword sentiment value should be assigned by, for instance, the scoring component 110. A keyword sentiment value, as used herein, refers generally to an inferred sentiment associated with a word. For instance, the word “great” supplementing or describing a keyword may be inferred to have a positive keyword sentiment while the word “lacking” is likely going to be associated with a negative keyword sentiment value. Keyword sentiment values may be numerical values assigned from a predetermined range of numerical values. By way of example only, the range of values may include a value at the upper end of the range having a positive sentiment value and a second value at the lower or opposite end of the range having a negative sentiment value. If the frequency of the keyword is greater than the predetermined value X then a keyword sentiment value is assigned to the keyword. Keyword sentiment values may be identified for multiple keywords in a single piece of content. For example, the statement “great battery life but camera quality has gone down” would result in a positive sentiment for the battery keyword but a negative sentiment for the camera keyword.

Related terms for a keyword may be identified by the system 100. A keyword may be referred to using related or similar terms within the content. The related terms may be a synonym, hyponyms, hypernyms, and possibly meronyms. For example, a review may state “the photos that I took from Smartphone X are really amazing.” Clearly this is a review about a camera of a product. Hence, for every given keyword the system 100 may compute a space of local terms using lexicon ontology or vertical specific ontology. By capturing related terms, the system 100 is able to identify keyword frequency and/or sentiments for content that may have otherwise been discarded as not including a keyword. This, in turn, will further improve the identified sentiments.

The sentiment analysis component 109 may also utilize facial expression recognition technology to identify a facial expression of a user. Facial expression recognition technology may include any known means for identifying a facial expression of a user. When facial expressions are identified, each expression may be assigned an emotion score by, for instance, the scoring component 110. By way of example only, scores may be a numerical value from a predetermined range where one end of the range indicates a positive mindset while the opposite end of the range indicates a negative mindset. For example, emotion scores may be assigned a value ranging from 0-1 with 1 being the most positive value and 0 being the least positive (or most negative) value in this case. An emotion score of 0.2 would likely indicate that a user has a negative emotion or mindset toward the content viewed at the time the facial expression was captured.

Once individual sentiment values (e.g., emotion scores and keyword sentiment values) have been scored by the scoring component 110, it is determined whether the overall sentiment is greater than a predetermined value Y. The overall sentiment can be a sum of the keyword sentiment value and the emotion value (if any). Alternatively, the overall sentiment may be calculated in other methods such as using a weighted algorithm, etc. In cases where a facial expression is not captured, the keyword sentiment value may represent the overall sentiment. When the overall sentiment is less than a predetermined value Y, the content is associated with an overall negative sentiment. When the overall sentiment is greater than a predetermined value Y, the content is associated with an overall positive sentiment.

The overall sentiment may be utilized to organize keywords and/or content into lists to associate with a user profile. For example, content having a positive sentiment is associated with a first list while content having a negative sentiment is associated with a second list. The content and each of the values is associated with the appropriate list based on the overall sentiment. The user profile database 104 including the respective lists may be queried based on sentiment (e.g., provide all keywords/content associated with a certain sentiment), by keyword (e.g., extract sentiment values associated with a particular keyword), and the like.

Returning to FIG. 1, the ranking component 111 is configured to rank the content of each list according to the sentiment of the content. For instance, the first list may organize the content such that the content having the most positive sentiment (e.g., highest positive sentiment numerical value) is first and followed by content having lesser sentiment values (but still positive). Similarly, the second list may organize the content such that the content having the most negative sentiment (e.g., lowest sentiment value) is first and followed by content having higher sentiment values (i.e., less negative sentiment values). The ranking component 111 may be configured to rank the list in a variety of ways to optimize functions of the system 100. This ranking may occur as sentiment information is identified, as micro-location information is identified, or a combination thereof. In other words, the ranking component 111 may rank the lists either before a micro-location of a user is identified or after a micro-location of a user is identified. The ranked lists may be stored in the user profile database 104.

The generating component 112 is configured to generate, select, or provide personalized targeted content when the user is near or approaching the item of interest based on micro-location indications. A micro-location indication refers generally to any output of micro-location technology. In other words, the micro-location indication may be an identification of a user's location, a signal including information that is used to identify a user's location (by another device, for example), or the like. As discussed below, micro-location technology may be utilized by the generating component to identify a particular product that a user is near. Once a product is identified, the enhanced user profile may be referenced to identify the sentiment data associated with the product.

The micro-location indications, as previously mentioned, may be communicated when a user is near or approaching the item of interest. “Near or approaching” refers to a distance that is within a predetermined distance. The entry of a user within the predetermined distance may be dynamically determined. Various micro-location indications may be provided based on location ranges. For example, an initial micro-location indication may be provided when a user is within 50-100 feet of an item while another indication may be provided when a user is within 2 feet of an item. These are merely exemplary distances. Any distance satisfactory to the system 100 and/or content provider may be utilized. Additionally, distances are not the only metric with which to measure. For instance, in a retail setting, an initial micro-location indication may be communicated when a user enters the retail store or a section of a retail store while subsequent micro-location indications may be communicated based on distance or other metrics relative to one or more items of interest.

The micro-location indications may cause the generating component 112 to generate, select, or provide personalized targeted content based on the sentiment of the user. The personalized targeted content may be advertisements, offers, videos, messages, or the like. The personalized targeted content may be focused on positive sentiment or negative sentiment. For instance, it may be desirable to provide users with positive sentiment items in order to further encourage interest in the form of, for instance, a purchase. Alternatively, it may be desirable to provide targeted content addressing the negative sentiment content to alleviate concerns of the user.

In alternative embodiments, the personalized targeted content may be pre-supplied from a retailer, marketer, and the like. A marketer can provide individual sub-videos corresponding to various keywords of the product. The generating component 112 may evaluate the sub-videos and assemble a personalized video according to the ranked lists. In particular, the generating component 112 may organize sub-videos associated with a positive sentiment to be displayed first followed by sub-videos associated with lesser positive sentiments, and so on. Alternatively, instead of providing sub-videos, a marketer could simply tag a video with various keywords such that the contents of the video are re-ordered so that the section of the video corresponding to the first item in the ranked list of features having a positive sentiment is shown first.

The communicating component 113 is configured to communicate the personalized targeted content. The communication of the content may be done in various ways. Initially, the personalized targeted content may be communicated directly to the user and, thus, a user device associated with the user such as, for example, the user's smartphone or tablet. Alternatively, the personalized targeted content may be communicated to a device associated with the item of interest. For instance, many retailers include devices next to products in the retail store that provide product information such as videos, demos, etc. on the device. The personalized targeted content may be communicated to the device next to the product such that the personalized targeted content plays at the retail store device when the user is within a predetermined distance from the retail store device and/or the product.

In additional embodiments, the communicating component 113 communicates the personalized targeted content such that more than one user is targeted at the same time and/or at the same device. For example, assume that a first user and a second user are located at nearly identical micro-locations such as standing side-by-side in a product section viewing the same product. A product device associated with the product may provide targeted content directed to both the first user and the second user. In this situation, the personalized targeted content would be generated, selected, or provided using a cumulative ranked list for the users. In other words, each ranked list for each of the first user and the second user (e.g., the first user's first list (positive) and the second user's first list (positive), the first user's second list (negative) and the second user's second list (negative)) may be combined and re-ranked to provide a cumulative list for one or more users. Any other way of providing a cumulative list for a plurality of users may be utilized.

The communicating component 113 may additionally or alternatively communicate the sentiment data to a third-party user. A third-party user may be any party besides the user for which the sentiment data applies. Exemplary third-party users include retail store representatives (e.g., salespeople). The sentiment data may be used by the third-party users to quickly identify content that was of interest and positive to a user and content that the user felt negatively about or had apprehensions. This enables the third-party user to utilize the sentiment data to provided targeted content, for example, to boast on the positive sentiment items or to alleviate concerns associated with negative sentiment items.

The invention described herein may be utilized by several entities including end users viewing content, retailers distributing items associated with viewed content (e.g., Wal-Mart, Best Buy, etc.), and the like. For instance, take an example where a user is viewing a camera online. The user may be viewing an item description page on a retailer's website. The user's activity is monitored (as described hereinabove) to determine content that is of interest to a user and whether the content is or contributes to a positive or negative sentiment. The monitoring may be performed by a third-party service engaged with the retailer. The retailer may then utilize micro-location technology (e.g., beacons) installed in their retail location to link beacon data, for example, with sentiment data. The third-party service may be linked to the micro-location technology of the retailer such that the third-party service manages the sentiment data and the micro-location data in order to provide appropriate targeted content at the right time. As illustrated, a single service (i.e., third-party service in this example) may utilize the invention. However, alternatively, the invention may be implemented across multiple services, sub-services, a combination of data plugins, etc.

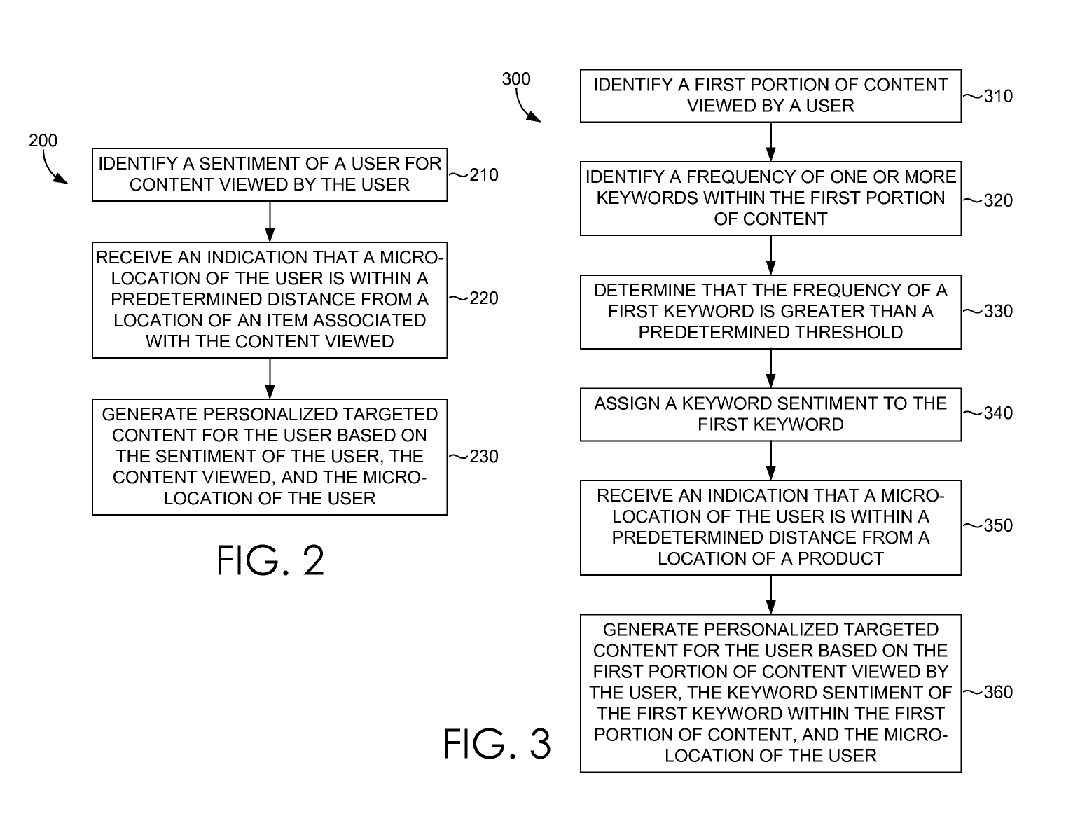

Turning now to FIG. 2, a flow diagram is illustrated showing a method 200 for generating personalized targeted content, in accordance with an embodiment of the present invention. At block 210, a sentiment of a user for content viewed by the user is identified. A sentiment of a user may be identified by evaluating keyword sentiments, facial expression emotion scores, and the like. The sentiment of a user may be represented by a numerical value that is classified as a positive sentiment or a negative sentiment.

At block 220, an indication that a micro-location of the user is within a predetermined distance from a location of an item associated with the content viewed is received. The micro-location of the user may be within a retail environment and within the predetermined distance from, for example, a product that is the subject of the content.

Upon receiving the micro-location indication, personalized targeted content is generated for the user based on the sentiment of the user, the content viewed, and the micro-location of the user at block 230. The personalized targeted content may be an advertisement, an offer, a message, a video, and the like. The sentiment of the user is utilized to identify content associated with a positive sentiment and content associated with a negative sentiment so that the targeted content is focused on the correct content. The personalized targeted content may be communicated directly to the user via various devices.

FIG. 3 is another flow diagram showing a method 300 for generating personalized targeted content, in accordance with embodiments of the present invention. Initially, at block 310, a first portion of content viewed by a user is identified. At block 320, a frequency of one or more keywords within the first portion of content is identified. The keywords may be identified by the system, such as system 100, or may be provided by the content provider associated with the first portion of content.

Keywords sentiments may be associated with keywords in order to determine an overall user sentiment. Keyword sentiments are, in embodiments, only associated with keywords that appear with a certain frequency within the content. Thus, a determination whether the keyword is present at a frequency greater than a predetermined threshold is made. At block 330 it is determined that the frequency of a first keyword is greater than a predetermined threshold. A keyword sentiment is then assigned to the first keyword at block 340. At block 350, an indication that a micro-location of the user is within a predetermined distance from a location of the product associated with the first portion of content is received or identified. Additionally micro-locations may be received prior to this such as a micro-location indication that the user has entered a retail establishment. The micro-location indications may include coordinates of a location, an identified product, neighboring products, and the like. The micro-location indications may be communicated upon a determination that the user is within a predetermined distance from a location of the product. This may be determined in real-time as a user approaches the product. The indication may also be determined using multiple micro-location components by, for example, identifying that a user is outside of the predetermined distance from the location of the product but within X distance from the predetermined distance. This “approaching” determination may assist in quickly identifying a micro-location of a user. In embodiments, the micro-location information is received after sentiment data, such as keyword sentiments, has been collected.

Upon receiving the micro-location indication, personalized targeted content is generated (or selected or provided) at block 360 for the user based on the first portion of content viewed by the user, the keyword sentiment of the first keyword within the first portion of the content, and the micro-location of the user.

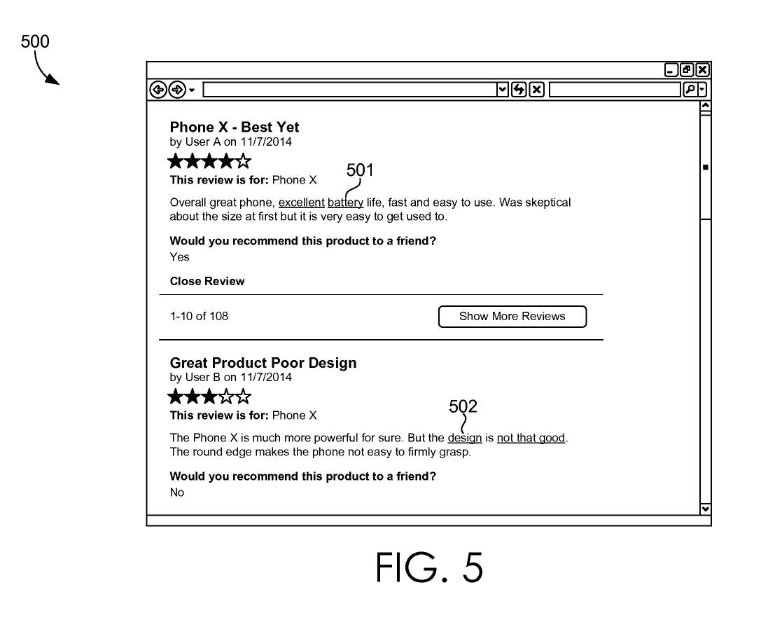

By way of example only, FIG. 5 provides an exemplary snapshot 500 of content viewed. The snapshot 500 in this case is a user review section for a Phone X product. The content may be product features, item descriptions, or any other viewable online content. Within content viewed, one or more keywords may be identified. Any known method of identifying keywords may be utilized. In embodiments, keywords are identified from a pre-populated list of keywords for a particular product. In this instance, keywords identified may be keyword 501 “battery” and keyword 502 “design” for example. A keyword sentiment may be identified for each identified keyword utilizing the content viewed. For instance, in this case the keyword 501 is described as “excellent” (i.e., “excellent battery life”) while the keyword 502 is described as “not that good.” A positive keyword sentiment may be associated with the keyword 501 as “excellent” is likely to be inferred as a positive description while the keyword 502 is associated with a negative keyword sentiment as it is associated with the description “not that good.” This information may be stored in association with a user profile for the particular product reviewed. The keyword sentiment values may also be used to identify the overall sentiment (as described above).

Once the sentiment value is identified, it may be used in combination with micro-location technology to provide targeted content. Micro-location information may be communicated from micro-location technology that is, for example, installed in a retail store location. The micro-location information may include a micro-location of a user, geographical coordinates identifying a location, locations of one or more items of interest, and the like. In particular, a location of Phone X (the item of interest in snapshot 500) and a location of the user that viewed the snapshot 500 may be included in the micro-location indication. When a user is within a predetermined distance from Phone X, a micro-location indication may be communicated indicating such. The sentiment data for an identified item (e.g., Phone X) may be identified. The identified item may be included in the micro-location indication. The items identified in the micro-location indications may be utilized to find corresponding sentiment data from an enhanced user profile. Using the identified items, corresponding sentiment data may be identified and used to provide targeted content. In this example, the sentiment data corresponding to Phone X is a negative sentiment toward design and a positive sentiment toward battery. Thus, targeted content may include an advertisement for the Phone X that mentions the battery life, a link to a video going over features of Phone X that highlights battery life, and the like. Targeted content may also include content that addresses the design concern of the user such as, for example, a user review indicating that the design is not an issue or a link to a video that highlights benefits of the design. The targeted content may be provided directly to a user device of the user (e.g., the user's mobile phone, tablet, etc.). Additionally, targeted content may be provided directly to devices located within the retail store that are associated with a micro-location near that of the user and/or the item of interest. In the example of Phone X, the targeted content may be provided to a demonstration Phone X set up for customer's to view. The retail store may have one or more devices set up at the product location for the purpose of displaying content related to the associated product. For instance, a tablet may be set up next to a Phone X display to provide content to customers and the targeted content may be provided to those devices located at a product location.

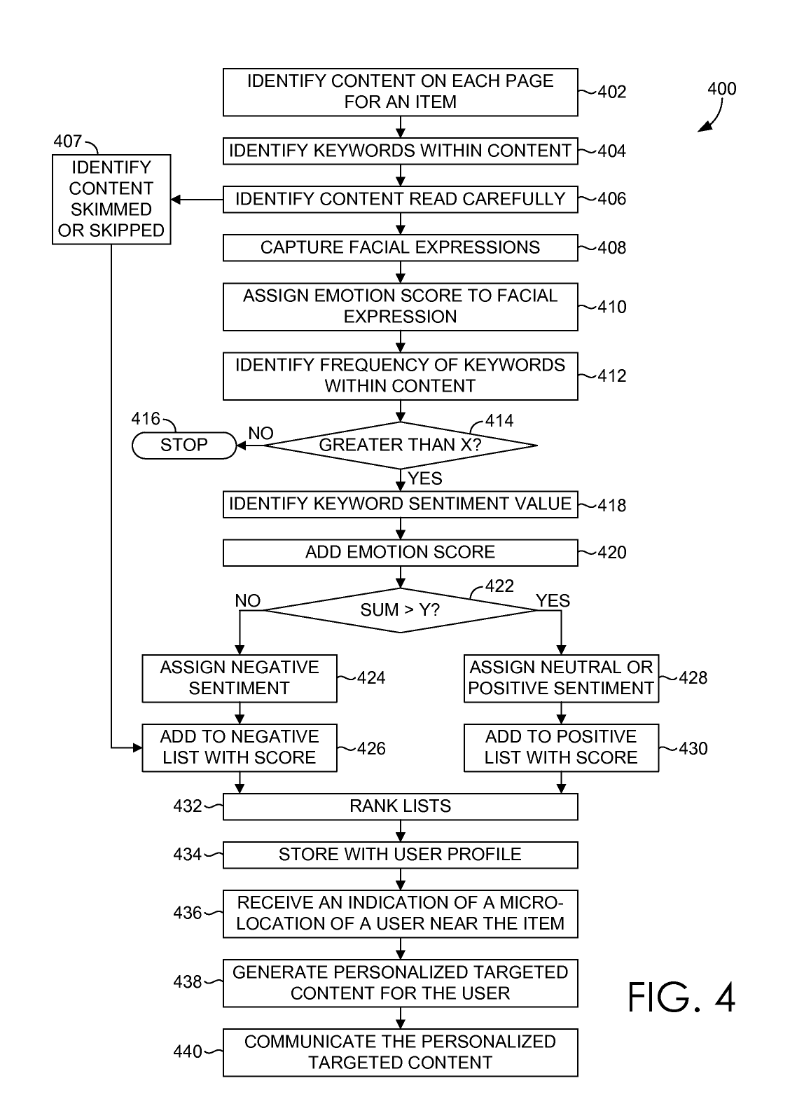

Turning now to FIG. 4, another flow diagram showing a method 400 for generating personalized targeted content is provided, in accordance with embodiments of the present invention. FIG. 4 is provided merely to be illustrative of the overall concept of the invention. Various steps in FIG. 4 may be omitted as well as performed in different orders than that which is illustrated in the method 400.

Initially, at block 402, content on each page for an item is identified. As previously explained, one or more pages of content may be provided by a content provider. Each page may include different portions of content such as, for example, product descriptions, user reviews, product features, etc., that are displayed within a content providers application, a web page, etc.

The content includes one or more keywords. The keywords may be relevant to an item of interest such as, for example, a product feature (e.g., a camera zoom strength for a camera, an eco-friendly cycle for a washer, etc.). The one or more keywords may be provided by the content provider as the content provider has a heightened awareness of relevant content. If the keywords are not provided by the content provider, the system (e.g., the system 100 of FIG. 1) may identify keywords within the content, as illustrated at block 404.

At block 406, content that is read carefully is identified while content that is skimmed or skipped is identified at block 407. Distinguishing between content that is read carefully, skimmed, or skipped may be performed by any method for tracking content review such as eye tracking technology, scroll tracking technology, or the like. If one or more keywords are not provided by the content provider, the identification of keywords may be performed by the system 100 after block 406 such that only content that is read carefully is reviewed for keywords.

Additionally, only content that is read carefully is analyzed for facial expressions at block 408. If captured, facial expressions are associated with an emotion score at block 410. The emotion scores may be numerical values indicating a positive or negative sentiment. For instance, assuming a range of 1-10, where 10 is the most positive score and 1 is the most negative score, a facial expression identified as ecstatic may be associated with a 9 or a 10 emotion score. Capturing facial expressions is an optional step and may be skipped. Should facial expressions not be available or captured, the method 400 would simply advance from block 406 to block 412 where a frequency of keywords within the content is identified. The frequency of keywords is evaluated to identify which keywords appear with a frequency greater than a predetermined value X. The determination of whether the frequency is greater than the predetermined value X is performed at block 414. If no keywords are present with a frequency greater than the predetermined value X, the method stops at block 416. If one or more keywords are present with a frequency greater than the predetermined value X, then a keyword sentiment value is associated with the keyword at block 418.

An overall sentiment value is desired in the present method 400. An overall sentiment value is a numerical value that represents a user's overall feeling to a portion of content, for example, based on at least a user's initial mindset toward the content (measured by evaluating what a user read carefully versus what they skimmed or skipped) and a keyword sentiment value indicating a tone or context of the content. Facial expressions may also factor into the overall sentiment value. When a facial expression is captured, the emotion score may be added to the keyword sentiment value at block 420 to identify the overall sentiment value (i.e., the sum of the emotion score (when present) and the keyword sentiment value).

An overall sentiment value is utilized to categorize the content as content with which the user associates a negative sentiment or content with which the user associates a positive sentiment. At block 422, a determination is made whether the overall sentiment value is greater than a predetermined value. If the overall sentiment value is not greater than the predetermined value Y, then the content is associated with a negative sentiment at block 424. If the overall sentiment value is greater than the predetermined value Y, then the content is associated with a positive sentiment at block 428. If the overall sentiment value is equal to the predetermined value Y, the content is associated with a neutral sentiment at block 428.

Once categorized as either a negative sentiment, a neutral sentiment, or a positive sentiment, the content is sorted into separate lists where a first list or positive list includes content associated with either a positive or a neutral sentiment and a second list or negative list includes content associated with a negative sentiment. Such sorting is illustrated at block 430 where the neutral or positive sentiment content is added to the positive list and at block 426 where the negative sentiment content is added to the negative list. Scores associated therewith are also added to respective lists.

Once sorted, the lists may be ranked at block 432. The rankings may be in any order desired. An exemplary ranking would include a highest numerical positive sentiment score item as first with each subsequent item listed in order of descending scores within the positive list. Similarly, the negative list may also be ordered with the lowest numerical negative sentiment score (i.e., the most negative content) as first with each subsequent item listed in order of ascending scores. The ranked lists may be stored with the user profiles to create an enhanced user profile at block 434. The ranked lists may be updated in real time as users access additional content. Additionally, new entries may be added to the ranked lists as they are received when the users access additional data.

The next portion of the method 400 occurs when micro-location information is received. An indication of a micro-location of a user near the item associated with the content is received at block 436. A micro-location initiation will initiate an application on a user's device. The application will then pass a unique identifier of the user to a server or the like such as, for example, the personalized targeted content engine 108 of FIG. 1. This may occur when a user enters a store, for instance. A unique identifier may be used to retrieve an output of displayed products near the micro-location of the user. The output of displayed products may be used in an API call to the user profile database 104 to retrieve the ranked listings or products the user is interested in that correlate to the products displayed. For each item of interest, corresponding features may be extracted from the ranked lists and used to generate personalized targeted content at block 438. The personalized targeted content may be in the form of an in-app message/push notification. The personalized targeted content is communicated to the user at block 440. The actual communication to the user may not occur until it is determined that the user is near the item. Alternatively, the communication may occur at any point designated in the system 100.

In embodiments, a mobile application of a third-party user other than the user for which the personalized targeted content was prepared may query the database storing the ranked list of features using an API so that the prospect/user can be targeted accordingly. This may be helpful to store representatives who wish to talk a user through features that they are worried about or who wish to see features that users are excited about so that they can use those items to their advantage. Furthermore, as previously explained, the ranked lists may be used to communicate personalized content to devices associated with products (e.g., tablets mounted next to a product). All of these uses have the potential to increase conversion.

Having described an overview of embodiments of the present invention, an exemplary operating environment in which embodiments of the present invention may be implemented is described below in order to provide a general context for various aspects of the present invention. Referring initially to FIG. 6 in particular, an exemplary operating environment for implementing embodiments of the present invention is shown and designated generally as computing device 600. Computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

Embodiments herein may be described in the general context of computer code or machine-useable instructions, including computer-executable instructions such as program modules, being executed by a computer or other machine, such as a personal data assistant or other handheld device. Generally, program modules including routines, programs, objects, components, layout structures, etc., refer to code that perform particular tasks or implement particular abstract data types. The invention may be practiced in a variety of system configurations, including handheld devices, consumer electronics, general-purpose computers, more specialty computing devices, etc. The invention may also be practiced in distributed computing environments where tasks are performed by remote-processing devices that are linked through a communications network.

With reference to FIG. 6, computing device 600 includes a bus 610 that directly or indirectly couples the following devices: memory 612, one or more processors 614, one or more presentation components 616, input/output (I/O) ports 618, input/output (I/O) components 620, and an illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventor recognizes that such is the nature of the art, and reiterates that the diagram of FIG. 6 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, layout structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, layout structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 612 includes computer storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors 614 that read data from various entities such as memory 612 or I/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc. The I/O components 620 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be equipped with depth cameras, such as stereoscopic camera systems, infrared camera systems, RGB camera systems, touchscreen technology, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

As can be understood, embodiments of the present invention enable the generation of personalized targeted content by using a combination of user sentiment and micro-locations. This allows for efficient targeting to consumers. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to generate personalized targeted content, comprising:
identifying a sentiment of a user for content viewed by the user, wherein sentiment is an overall impression of the user of the content viewed;
receiving an indication that a micro-location of the user is within a predetermined distance from a location of an item associated with the content viewed; and
generating personalized targeted content for the user based on the sentiment of the user, the content viewed, and the micro-location of the user.

2. The one or more computer storage media of claim 1, wherein identifying a sentiment of a user related to content viewed by the user further comprises:
identifying a first portion of the content as a description of the item; and
identifying whether the first portion of the content is read carefully, skimmed, or skipped based on monitoring via eye tracking technology or scroll tracking.

3. The one or more computer storage media of claim 2, further comprising:
identifying a second portion of the content as a user review of the item;
identifying whether the second portion of the content is read carefully, skimmed, or skipped based on monitoring via eye tracking technology or scroll tracking.

4. The one or more computer storage media of claim 1, wherein the personalized targeted content is one or more of an advertisement, an offer related to the item, and a message related to the item.

5. The one or more computer storage media of claim 1, wherein the micro-location is acquired utilizing one or more of a micro-location beacon, Bluetooth low energy (BLE), and near field communication (NFC).

6. The one or more computer storage media of claim 1, wherein identifying a sentiment of a user comprises:
identifying a mindset of the user, wherein identifying the mindset of the user includes identifying whether the content viewed by the user has been read carefully, skimmed, or skipped based on monitoring via eye tracking technology or scroll tracking; and
identifying a context of the content viewed by the user, wherein the context is based on one or more keywords included in the content viewed by the user and is represented by either a positive context or a negative context.

7. The one or more computer storage media of claim 6, further comprising generating a first list including content viewed by the user that is associated with a positive sentiment, wherein a positive sentiment represents content that has been read carefully by the user and has a positive context.

8. The one or more computer storage media of claim 7, further comprising generating a second list including content viewed by the user that is associated with a negative sentiment, wherein a negative sentiment represents content that has been either skimmed or skipped by the user or has a negative context.

9. The one or more computer storage media of claim 8, further comprising storing the first list and the second list in association with the user's profile to create a first enhanced user profile.

10. The one or more computer storage media of claim 9, further comprising:
identifying a second enhanced profile associated with a second user that is determined to be near the item based on a second micro-location of the second user;
combining the second enhanced profile with the first enhanced profile;
providing combined personalized targeted content for each of the first user and the second user at a device located near the location of the item.

11. The one or more computer storage media of claim 1, further comprising:
providing the personalized targeted content to a device associated with the item.

12. The one or more computer storage media of claim 1, further comprising capturing one or more facial expressions of the user while viewing the content, wherein the one or more facial expressions are captured utilizing facial recognition technology.

13. A computerized method for generating personalized targeted content, the computerized method comprising:
identifying a first portion of content viewed by a user, wherein the first portion of content is a description of a product;
identifying a frequency of one or more keywords within the first portion of content;
determining that the frequency of a first keyword is greater than a predetermined threshold;
upon determining that the frequency of the first keyword is greater than the predetermined threshold, assigning a keyword sentiment to the first keyword, wherein the keyword sentiment is either a positive sentiment or a negative sentiment;
receiving an indication that a micro-location of the user is within a predetermined distance from a location of the product; and
upon receiving the micro-location of the user, generating personalized targeted content for the user based on the first portion of content viewed by the user, the keyword sentiment of the first keyword within the first portion of content, and the micro-location of the user.

14. The computerized method of claim 13, further comprising:
generating a first list including content viewed by the user that is associated with an overall positive sentiment, wherein an overall positive sentiment represents at least a portion of content that has been read carefully by the user and includes one or more keywords associated with the positive sentiment;
generating a second list including content viewed by the user that is associated with an overall negative sentiment, wherein an overall negative sentiment represents content that has either been skimmed or skipped by the user or includes one or more keywords associated with a negative sentiment; and
storing the first list and the second list in association with the user's profile to create an enhanced user profile for the user.

15. The computerized method of claim 13, wherein the personalized targeted content is one or more of an advertisement for the product, an offer for the product, and a message related to the product.

16. The computerized method of claim 13, further comprising providing the personalized targeted content to at least one of a user device of the user or a product device associated with the product and located at the location of the product.

17. A computerized system comprising:
a datastore storing enhanced user profiles;
one or more processors; and
one or more computer storage media storing computer-useable instructions that, when used by the one or more processors, cause the one or more processors to:
identify at least a first portion of content for a product viewed by a user;
for the first portion of content, identify one or more of:
(a) a context of the first portion of content determined by whether the first portion of content was read carefully by the user, skimmed, or skipped, as determined by monitoring via eye tracking technology or scroll tracking;
(b) whether the first portion of content is a product description or a user review; and
(c) one or more facial expressions of the user while viewing the first portion of content;
identify one or more keywords within the first portion of content along with a keyword sentiment, wherein the keyword sentiment is either positive or negative;
receive a micro-location for the user indicating that the user is within a predetermined distance from the product; and
generate personalized targeted content for the user based on the micro-location of the user and a sentiment of the user, wherein the sentiment of the user is an overall impression of the user of the product based on the first portion of content viewed and the keyword sentiment of one or more keywords within the first portion of content.

18. The system of claim 17, wherein the one or more processors further associate an emotion value to each of the one or more facial expressions, wherein the emotion value is a numerical value indicating a positive facial expression, a neutral facial expression, or a negative facial expression.

19. The system of claim 17, wherein content is categorized and ranked based on the sentiment of the user.

20. The system of claim 17, wherein the sentiment of the user is dynamically updated as additional content is viewed.
